(19) United States
(12) Patent Application Publication
(10) Pub. No.: US 2004/0150148 A1
(43) Pub. Date: Aug. 5, 2004

(54) Support for automotive parts

(75) Inventors: Battista Luca, Reading, PA (US); Jeffrey Loeper, Reading, PA (US)

Correspondence Address: BROWN, RAYSMAN, MILLSTEIN, FELDER & STEINER LLP, 900 THIRD AVENUE, NEW YORK, NY, 10022, US

(73) Assignee: Penske Truck Leasing Co., L.P., Reading, PA (US)

(21) Appl. No.: 10/736,265

(22) Filed: Dec. 15, 2003

Related U.S. Application Data
(60) Provisional application No. 60/444,166, filed on Jan. 31, 2003.

(30) Foreign Application Priority Data
Jan. 31, 2003 (CA) 2,418,028

(51) Int. Cl. B25B 27/14

(52) U.S. Cl. 269/17

(57) ABSTRACT

The invention provides moveable supports for machine parts such as automotive body components during repair, painting, assembly, alignment, and other processes. The provision of multiple, spaced frame and support members of suitable length, spacing, and orientation, enables workers to access all surfaces of supported components; and support members having angled flange portions enable access to portions of supported components engaged by the support members. Supports according to the invention can be employed as jigs to support parts during, for example, assembly, disassembly, and/or alignment of components. The provision of wheels, brackets, lugs, hooks, and other devices enable easy and safe transportation for support devices and supported components.

This application claims the benefit of U.S. Provisional Patent Application Serial No. 60/444,166, entitled Support for Automotive Parts and filed 31 Jan. 2003; and priority from Canadian Patent Application Serial No. 2,418,028, entitled Support for Automotive Parts and filed 31 Jan. 2003.

### BACKGROUND OF THE INVENTION

The invention relates to moveable support devices for machine parts such as automotive components, including for example truck or tractor hoods and other automobile body parts. The support is useful in processes such as painting, repairing, assembling, aligning and transporting parts.

Supports for automotive components are disclosed in U.S. Pat. No. 1,603,595 to Hansen; U.S. Pat. No. 5,296,030 to Young; U.S. Pat. No. 5,660,637 to Dodge; U.S. Pat. No. 5,720,817 to Taylor; and others.

### SUMMARY OF THE INVENTION

The invention provides moveable support devices for machine parts such as automotive body components. Devices according to the invention provide support for parts during repair, painting, assembly, alignment, and other processes, while providing improved access by workers to surfaces of supported components, thus reducing or eliminating, for example, the need for the worker to move or reset the component to obtain access to each of its surfaces for repair or other work.

In supporting components comprising multiple subcomponent parts, supports according to the invention can be employed as jigs to support the parts securely and precisely in place during, for example, assembly, disassembly, and/or alignment of components. This can reduce or eliminate the need for separate jigs and can improve efficiency and worker safety in the workshop, and reduce the risk of damage to the automotive body component.

Supports according to the invention provide improved access to surfaces of supported components in several ways. For example, the provision of multiple, spaced frame and support members, of suitable length and orientation, enables workers to access all surfaces, both upper and lower, inner and outer, etc, of supported components. As a further example, the use of channel shaped support members having angled flange portions enables access to even those portions of supported components engaged by the support members.

By being provided with wheels, brackets for engaging forklifts, lugs, hooks, and other devices for engaging lift equipment, and/or other means for moving, support devices according to the invention facilitate easy and safe transportation for machine components, including parts that are large, heavy or unwieldy, thus reducing or eliminating the need for forklifts or other lifting equipment to transport supported components.

Among other advantages, support devices according to the invention provide increased efficiency and safety in the workshop.

In one embodiment, a moveable support according to the invention comprises a frame or base that includes a plurality of support members, or holders. At least one of the holders or support members includes a support attached to the frame configured to receive and at least constrain an edge of an automotive body part, for example through provision of a channel-shaped portion, or a bracket, that comprises a pad or saddle, or other support surface; while the same or another member or holder provides an attachment such as a pin and lug adapted to releasably engage a mounting feature such as a hood hinge attachment provided on the automotive body part. The plurality of support members are long enough, and sufficiently spaced from each other, and suitably oriented, to permit access to substantially an entire surface—that is, substantially all of all surfaces, upper, lower, inner, outer, etc.—of the automotive body part, by a worker disposed on a work surface, such as a shop floor, upon which the moveable support is positioned. For example, the support members or holders can extend generally upward from the frame to facilitate access by workers to a supported part.

Support frames according to the invention may include three or more support members. Provision of three or more support members, suitably configured and spaced in relation to the configuration of the supported component, can provide increased stability for supported parts while reducing loads induced in the supported parts by the support. For example, a three- or more point support can provide brackets for supporting one or more edges of the body part by gravity, and one or more attachments for mating with one or more pre-existing mounting features of the supported component.

In one aspect the invention can provide a moveable support device for an automotive body part, the device comprising a movable frame; at least one support extending at least generally upwardly from the frame having a holder configured to receive and at least constrain an edge of the automotive body part; and at least one other support extending at least generally upwardly from the frame having a holder configured to releasably engage structure on the automotive body part used to secure the automotive part to a vehicle. The at least one holder and the at least one other holder are positioned so that the respective holders support the automotive body part while permitting access by a worker to substantially an entire under surface, relative to the automotive body part as supported by the support device, of the automotive body part.

In another aspect the invention can provide a support device for an automotive body part, the moveable support device comprising a frame including a plurality of support members. The plurality of support members extend at least generally upward from the frame, relative to a work surface upon which the support device is located. At least one of the support members is configured or otherwise adapted to support an edge of an automotive body part, and at least one of the support members includes an attachment to engage a mounting feature of the automotive body part. The support members long enough, and sufficiently spaced from each other, to permit access to substantially an entire surface of the automotive body part by a worker disposed on the work surface.

As will occur to those familiar with the applicable arts, upon reviewing this specification, a great many configurations of support devices according to the invention are possible and will serve to accomplish the purposes described herein.

### BRIEF DESCRIPTION OF THE FIGURES

The invention is illustrated in the figures of the accompanying drawings which are meant to be exemplary and not limiting, and in which like references are intended to refer to like or corresponding parts.

FIG. 1 is a perspective view of a preferred embodiment of a device for supporting automotive parts according to the invention.

FIG. 2 is a perspective view of a preferred embodiment of a device for supporting automotive parts according to the invention.

FIGS. 3a and 3b are partial perspective views of a preferred embodiment of a holder or support member of a device for automotive parts according to the invention.

FIGS. 4a and 4b are partial perspective views of a preferred embodiment of a holder or support member of a device for supporting automotive parts according to the invention.

FIG. 5 is a partial perspective view of a preferred embodiment of a holder or support member of a device for supporting automotive parts according to the invention.

### DETAILED DESCRIPTION OF THE PREFERRED EMBODIMENTS

Preferred embodiments of methods, systems, and apparatus according to the invention are described through reference to the Figures.

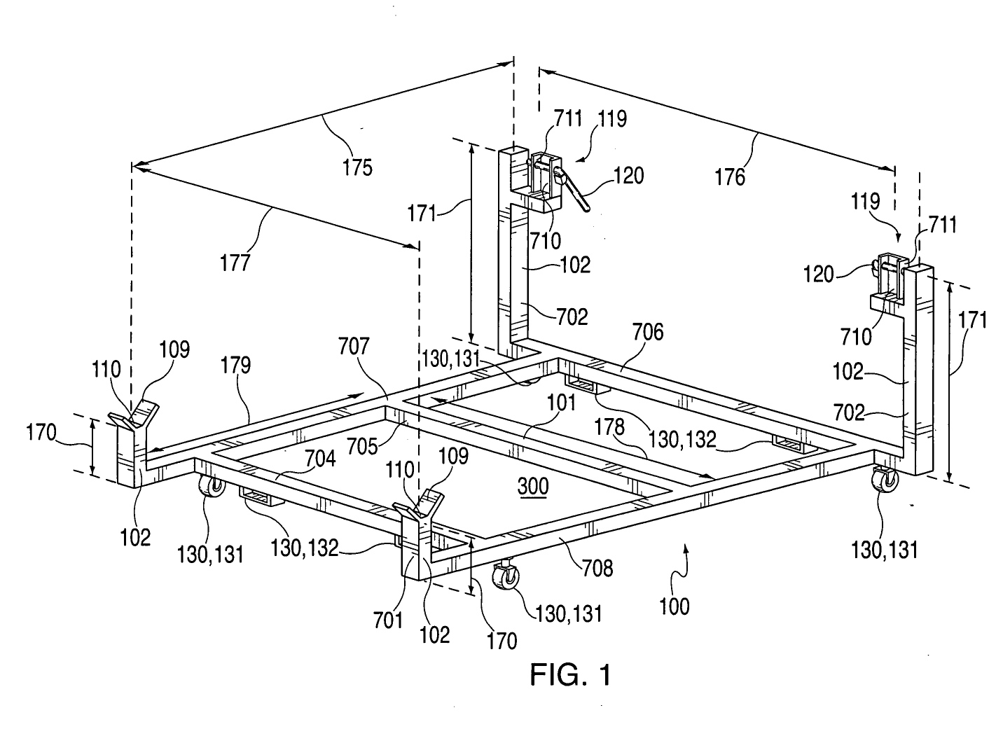

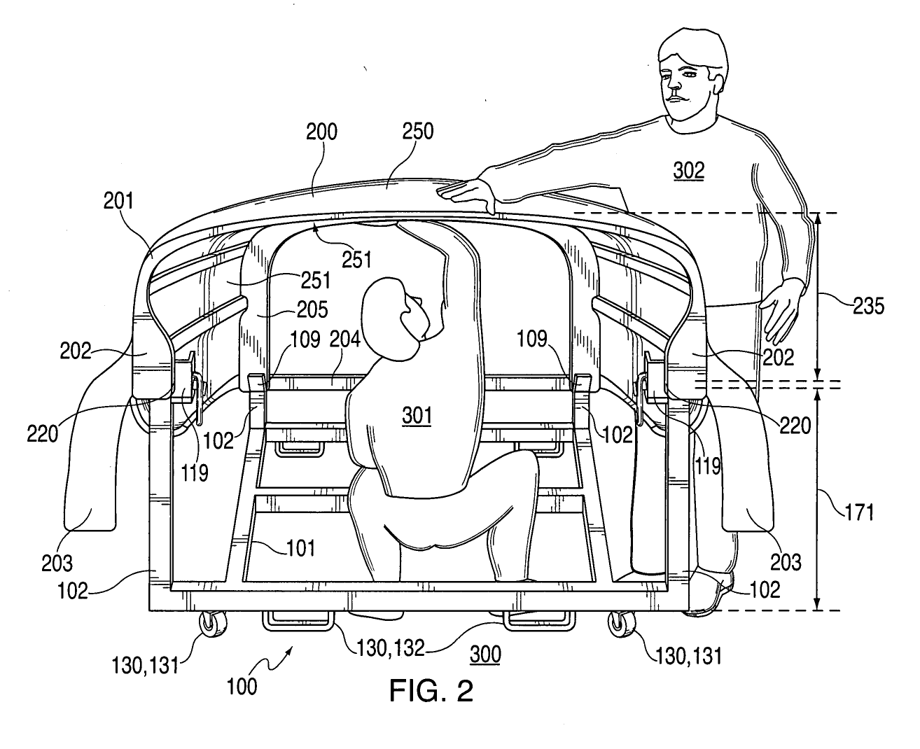

FIGS. 1 and 2 provide perspective views of a preferred embodiment of a device for supporting automotive parts according to the invention. Moveable support device 100 comprises frame or base 101, which includes a plurality of holders or support members 102, 109, 119. Holders/support members 109 comprise saddles or support surfaces 110 for constraining or otherwise supporting edges of automotive or other machine parts, and holders/support members 119 comprise attachments for engaging mounting features of such parts. Members 102 are, as shown in FIG. 2, long enough, and sufficiently spaced from each other and from other portions of frame 101, to permit access to substantially the entire surface of a part supported by the members by a worker disposed on work surface 300 upon which the moveable support is positioned. Moreover, holders 102 are at least generally upwardly extending from base or frame 101. For example, lengths 170, 171 of, and spacings 175, 176, 177 between, support members 102, and spacings 178, 179 between other portions of frame 101 are sufficient, when taken in conjunction with the configuration of a supported part 200 (FIG. 2), as for example depth 235 of part 200, to permit access by worker 301 to underside and/or interior surfaces 251 of part 200, while worker 302 is enabled to access upper and/or exterior surfaces 250 of the part. Lengths 170, 171, and spacings 175, 176, 177, 178, and 179 can be sufficient, for example, to enable worker 301 to enter and stand, crouch and/or sit beneath part 200 and inside frame 101, while accessing part surfaces 250, 251. Particular dimensions suitable for frame and support members in facilitating access by workers can be determined by a number of factors or methods, as will be understood by those of ordinary skill in the art of designing such supports. Such dimensions can be determined, for example, by the type and nature of the parts to be supported, including their configuration, by the type of work to be performed on the parts, and by the size and abilities of the workers by whom the work is expected to be performed. For example, parts such as automotive hoods can comprise large arched or concave areas which can be taken into account in designing their supports, and typical anticipated worker design can be determined by measuring or otherwise assessing one or more workers.

To say that a holder or support member 102 is at least generally upwardly extending means, for example, that a portion of the support intended to constrain or otherwise support a portion of an automotive or other machine part is substantially higher, or further from a work surface 300, than other portions of the holder or support member.

The provision and proper configuration of three or more support members 102 on frame 101 can be used to provide stable, low-stress support for supported parts. For example, support members 102 can be spaced such that the center of gravity of the supported component 200 lies well within the footprint of base or frame 101, so that tipping of support 100 is rendered more difficult, or impossible, with consequent reduction of the risk of damage to component 200 and injury to workers 301, 302. Moreover, the provision of three or more supports 102 facilitates the support of component 102 without induced bending moments in the supported part. For example, component 200 may be supported on one or several support surfaces 110 and/or attachments 119, primarily under the influence of gravity, as opposed to clamping or gripping, as is commonly required in supports comprising fewer than three support points, thus without introducing bending or other forces such as can result from the use of clamps without spread support.

Supports according to the invention can be used, when suitably configured, to support multi-component parts in jig position, as for example during fabrication, assembly, or repair. For example, support 100 of FIG. 2 can be used to hold components 201, 202, 203, 204, individually or as assemblies or subassemblies, in a jig position while an automotive part such as a hood or other assembly is assembled, as for example by bonding, or while one or more of components 201, 202, 203, 204 are repaired or replaced. For example, the hood assembly shown in FIG. 2 can be assembled by placing cross-bar component 204 in brackets or channel-shaped portions 109 on support members 102; bonding the cross-bar component 204 to grill enclosure 205 to form a subassembly; placing bonding side parts 202, which comprise hood attachments 220, on attachments 119 and bonding them to the cross-bar and grill enclosure subassembly; bonding fenders 203 to side parts 202; and bonding hood 201 to the resultant assembly. Support members 102, comprising channel-shaped portions 109 and attachments 119, hold the individual components together so that the bonding process may be carried out.

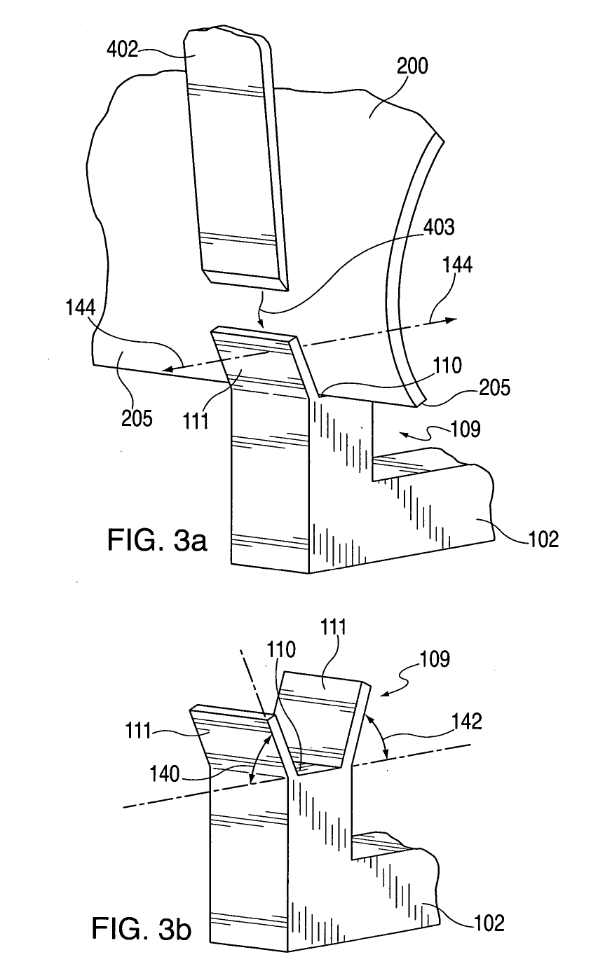

Support members 102, 109 can be adapted to support machine parts by providing support surfaces, or saddles, 110 to support one or more edges or other portions of the part, and one or more flanges 111 to form a bracket or channel-shaped portion for constraining the part and preventing it from falling off or otherwise losing the restraint of the support member. For example, as shown in FIGS. 3a and 3b, edge 205 or another portion of part 200 can be set upon saddle or support surface 110, between flanges 111, to both hold the part up and prevent slippage or other-movement of the part in the direction of arrows 144. Configuring flanges 111 at one or more angles 140, 142 from the plane of the saddle or support surface 110 allows part 200 to be supported by the member without compromising or substantially or unreasonably restricting access to the part for work such as bonding, painting, straightening, or other maintenance. For example, flanges 111 can be configured at angles 140, 142 of less than 90 degrees to allow freer access to supported portions of the part 200 by tool 402 and other instruments, including hands or fingers of workers 301, 302, via region 403.

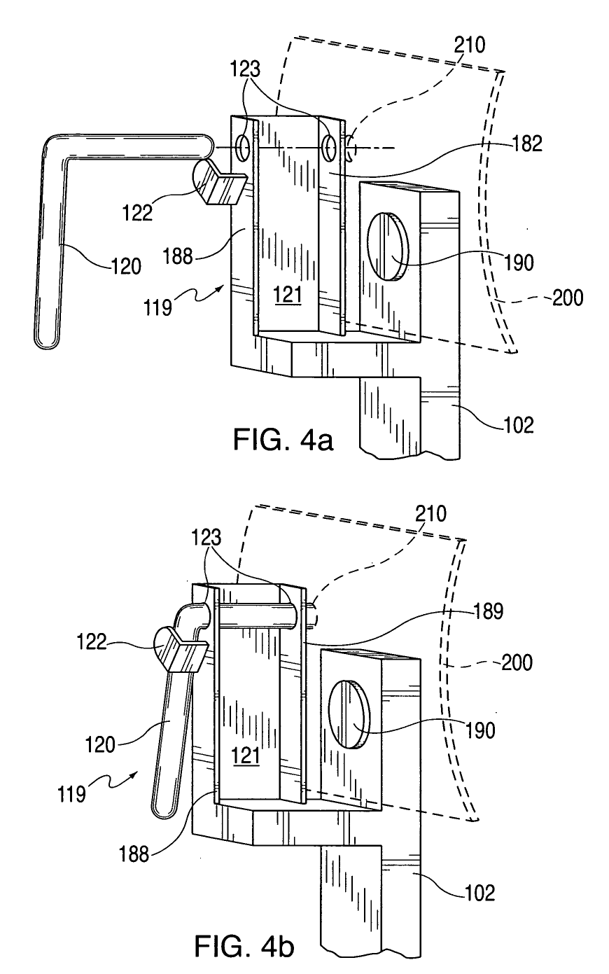

Support members 102 can provide attachments 119 for engaging mounting or other features of supported parts 200. For example, as shown in FIGS. 4a, 4b, attachments 119 can comprise pins 120 for engaging holes or other features 210 provided on part(s) 200 for mounting them on other assemblies, or for other purposes. In the example shown in FIGS. 4a, 4b, part 200 comprises a hole feature 210 and is placed on support member 102 such that feature 210 aligns with holes 127 in flanges 188, 189 of structure 121. Pin 120 is then placed through holes 127 to engage feature 210 (for example, a hood attachment for securing a hood to an automobile frame) and secure part 200 in place. Bracket 122 can be provided to hold pin 120 in place to secure part 200 in the supported position.

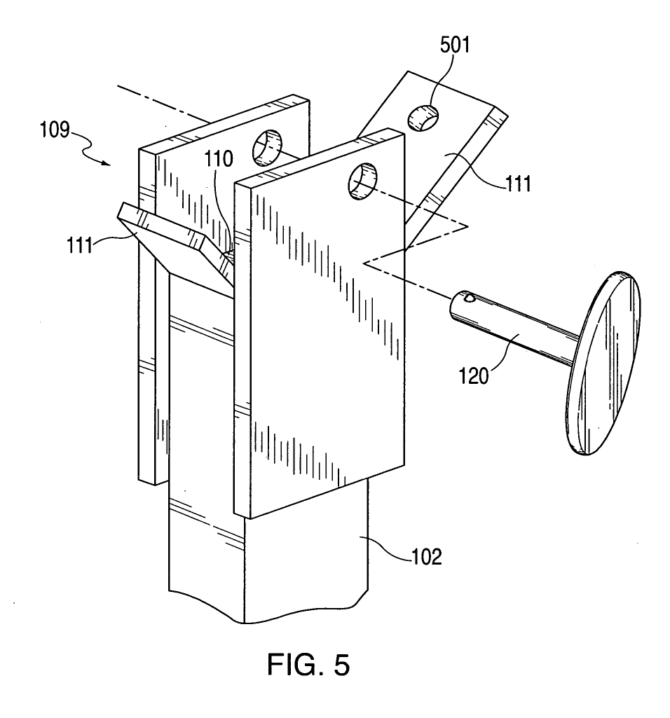

FIG. 5 illustrates an embodiment of a support member 102 comprising saddle or support surface 110 and angled flanges 111. Support member 102 of FIG. 5 further comprises side plates 500 with holes 502 for receiving and constraining pin 120, and hole 501, for engaging support features of a supported part 200. Plates 500, pin 120, and features and/or additional pins 120 engaged by hole 501 can engage various features of the supported part 200. As will be appreciated by those of ordinary skill in the art, a great variety of features such as plates 500, pin 120, holes 501, flanges 110, and support surfaces 110 can be used, alone or in various combinations, to support parts 200. A wide variety of additional features and/or devices, such as lugs, hooks, bolts, magnets, etc., can also be employed.

The precision with which part 200 is supported in a desired position can be-controlled by further measures, such as for example the provision of shims or other features 190. Such features can be used, for example, in controlling the position of part 200 so that part 200 can be held in a jig position, as described herein.

Supports according to the invention can comprise means 130 for moving the supports, for example for use in transporting supported parts or in positioning such parts for work. Such means can comprise, for example, wheels 131, optionally swivel-mounted, for rolling the support on a work surface such as a garage, workshop, or factory floor or parking lot; brackets 132 for receiving forks of a fork lift; lugs, hooks, or other structures for engagement by hooks or other lift equipment; and devices for lifting and/or moving the support and any attached structures by other manual or mechanical means.

The selection of suitable dimensions for various frame and support members of frame 100 will be determined by the dimensions of the components to be supported and by access requirements by workers 301, 302, and will be well within the skill of those of ordinary skill in such design arts, once they have been made familiar with this disclosure. For example, support 100 according to the invention may be fabricated according to the embodiment of FIGS. 1 and 2 in order to support a hood assembly for a 25-foot GMC moving truck selected, for example, from the C-, T-, or W-series of GMC trucks. Frame 101 comprises cross members 704, 705, 706, side members 707, 708. Frame members 704, 705, 706, 707, 708 and support members 102 are fabricated from steel tube, 3 inches×1.5 inches by 1/8 inch thick. Alternatively, some or all such members are fabricated from 2-inch square tube with 1/8 inch thick walls, and/or 2-inch angle iron, or similar structural steel. Cross members 704, 705, 706 are of length suitable for making dimension 176 between flanges 711 of pin support brackets 710 approximately 60.25 inches and dimension 177 between support surfaces 110 approximately 39 1/4 inches. Support members 701 are 10.5 inches long; support members 702 are long enough to make dimension 171 between cross member 706 and centerline of pin 120 23⅜ inches. Side members 707, 708 are long enough to make dimension 175 between pins 120 and support surfaces 110 approximately 55 3/4 inches. Cross members 704 and 705, and 705 and 706, are spaced by approximately 30 inches each. Brackets 132 for receiving fork lift blades are 7.5 inches wide and 3 inches deep, fabricated from ¼ inch steel plate. Flanges 111 are configured such that angles 140, 142 are between approximately 40 and approximately 95 degrees. Pins 120 are fabricated from ½ inch diameter steel rod, with pin lengths of approximately 8 inches.

To facilitate the support of multiple components, such as hoods for more than one model automobile or truck, one or more of frame members 704, 705, 706, 707, 708 and support members 102 may be made extendible between various lengths, as for example by using telescoping tubes for frame and/or support members, and locking pins for setting member lengths at desired, predetermined lengths suitable for supporting various components.

While the foregoing invention has been described in some detail for purposes of clarity and understanding, it will be appreciated by one skilled in the art, from a reading of the disclosure, that various changes in form and detail can be made without departing from the true scope of the invention in the appended claims.

What is claimed is:

1. A moveable support device for an automotive body part, comprising;
a movable frame;
at least one holder attached to the frame configured to receive and at least constrain an edge of the automotive body part;
at least one other holder attached to the frame configured to releasably engage structure on the automotive body part used to secure the automotive part to a vehicle;
the at least one holder and the at least one other holder being positioned to support the automotive body part while permitting access by a worker to substantially an entire under surface, relative to the automotive body part as supported by the support device, of the automotive body part.

2. The support device of claim 1 wherein the at least one holder comprises a channel-shaped portion.

3. The support device of claim 2, wherein the channel-shaped portion comprises a saddle and a flange, the flange angled with respect to saddle so as to accommodate work performed upon a portion of the automotive body part supported by the holder.

4. The support device of claim 1, wherein the automotive body part comprises at least two components, and the holders support the components in a jig position.

5. The support device of claim 1, wherein the at least other holder comprises at least one pin.

6. The support device of claim 1, comprising wheels for moving the support.

7. The support device of claim 1, comprising brackets attached to the frame for receiving forks of a fork lift.

8. A moveable support device for an automotive body part, comprising;
a movable frame;
at least one support extending at least generally upwardly from the frame having a holder configured to receive and at least constrain an edge of the automotive body part;
at least one other support extending at least generally upwardly from the frame having a holder configured to releasably engage structure on the automotive body part used to secure the automotive part to a vehicle;
the at least one holder and the at least one other holder being positioned so that the respective holders support the automotive body part while permitting access by a worker to substantially an entire under surface, relative to the automotive body part as supported by the support device, of the automotive body part.

9. A support device for an automotive body part, the moveable support device comprising a frame including a plurality of support members,
the plurality of support members extending at least generally upward from the frame, relative to a work surface upon which the support device is located;
at least one of the support members adapted to support an edge of an automotive body part;
at least one of the support members having an attachment to engage a mounting feature of the automotive body part;
the support members long enough, and sufficiently spaced from each other, to permit access to substantially an entire surface of the automotive body part by a worker disposed on the work surface.

10. The support device of claim 9, comprising at least three support members.

11. The support device of claim 9, wherein the automotive body part comprises at least two components, and the support members hold the components in a jig position.

12. The support device of claim 9, wherein the at least one support member having an attachment to engage a mounting feature of the automotive body part comprises at least one pin.

13. The support device of claim 9, comprising means for moving the support while an automotive body part is held by the support.

14. The support device of claim 13, wherein the means for moving the support comprise wheels mounted on the frame.

15. The support device of claim 13, wherein the means for moving the support comprise brackets attached to the frame for receiving forks of a fork lift.

16. The support device of claim 9, wherein the support member adapted to support an edge of an automotive body part includes a saddle and a flange, the flange angled with respect to the saddle so as to accommodate work performed upon a portion of the automotive body part supported by the support member.

17. The support device of claim 9, wherein the automotive body part comprises a hood, and the mounting feature comprises a hood attachment.

18. The support of claim 9, wherein the support members support the automotive part above the work surface, and the support members are long enough, and sufficiently spaced from each other, so that the worker can access substantially an entire underside of the automotive part while disposed between at least two of the support members, on a portion of the work surface beneath the automotive part.

19. In a moveable support device for an automotive body part, the moveable support device comprising a frame including a plurality of support members, the improvement wherein:
at least one of the support members includes a saddle and a flange adapted to support an edge of an automotive body part, the flange angled with respect to the saddle so as to permit work to be performed upon the edge while the automotive body part is supported by the support member.

20. The improvement of claim 19, wherein at least one of the support members comprises an attachment adapted to engage a mounting feature of the automotive body part.

21. In a moveable support device for an automotive body part, the moveable support device comprising a frame with a plurality of support members, the improvement wherein:
the support members are long enough, and sufficiently spaced from each other, so that when an automotive body part is supported by the support members a worker can access substantially an entire underside of the automotive part while the worker is disposed between at least two of the support members, on a portion of a work surface upon which the moveable support is disposed.
